(19) United States
(12) Patent Application Publication
(10) Pub. No.: US 2006/0081742 A1
(43) Pub. Date: Apr. 20, 2006

(54) Guardrail reflector/delineator mounting device

(76) Inventor: Guadalupe C. Garcia, Tijuana (MX)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/125,591

(22) Filed: May 9, 2005

Related U.S. Application Data
(60) Provisional application No. 60/570,176, filed on May 11, 2004.

(51) Int. Cl. F16M 11/00

(52) U.S. Cl. 248/200

(57) ABSTRACT

The invention provides new guardrail reflector/delineator mounting apparatuses, e.g., fasteners, clips, mounting brackets, and so on, and methods of mounting high visibility reflectors/delineators onto standard guardrails, concrete barriers, or any desired surface utilizing the same. The mounting apparatus has two main components: an adjustable portion and a mounting portion. The adjustable component is securely attached to or otherwise made a part of the mounting means and enables an end user to quickly extend or reduce, by hand or with a hand tool, the height of the mounting apparatus for a tight fit and secure hold onto the guardrail, concrete barrier, or desired surface. The mounting apparatus is made of aluminum, stainless steel, molded plastic, or other comparable durable, strong and weather resistant material, and can be installed in a fast and effortless manner without affecting the safety feature, display utility, and visibility of the reflectors/delineators mounted thereon.

### CROSS-REFERENCE TO RELATED APPLICATIONS

The present application claims priority from a provisional patent application No. 60/570,176, filed May 11, 2004, the entire content of which is incorporated herein by reference.

### FIELD OF THE INVENTION

The present invention relates generally to guardrails and more particularly to new designs and manufacture of a mounting apparatus for mounting guardrail reflectors/delineators and methods of mounting the same.

### DESCRIPTION OF THE BACKGROUND ART

Guardrail plays an important role in saving the lives of people involved in accidents. It is commonly installed on interstates, highways, secondary roads, curved roads, road sides, bridges, corners, or even parking lots to shield vehicles from natural and man-made roadside hazards, such as cliffs, trees, rivers, ditches, utility poles, railroad tracks, signs, etc. For safety, strength, durability, and cost effectiveness, standard guardrail is made of 10-12 gauge, zinc plated galvanized steel.

Galvanized steel gives guardrail a dull, monotonous general appearance. Thus, most people often do not notice or pay attention to its existence until an accident occurs and it saves lives or prevents dreadful things from happening.

A variety of rail markers, delineators, reflectors, and the likes are available today to enhance guardrail's visibility and warn or otherwise inform drivers/motorists of danger. They are becoming increasingly desirable or even essential wherever guardrail, or “guard rail”, is utilized.

Most of the existing guardrail reflectors/delineators are fabricated with prismatic and/or reflective materials. Some of these products require drilling holes through the guardrail to be permanently mounted thereon. Some are mounted through the center rail support bolts that are part of standard guardrails. A product named “Rail Bright” by US Reflector of Worcester, Mass., can be temporarily mounted on the guardrail without screws, glue, or tape. However, if permanent fixation is required, Rail Bright must be installed with double-sided pressure sensitive tape and/or aluminum rivets. Rail Bright is made of pre-formed (molded) plastic coated with a reflective film by 3M™.

Clearly, there is a continuing need in the art for new designs and manufactures of mounting apparatuses that enable fast, easy, and cost effective ways of securely mounting reflectors/delineators onto guardrails without glues, adhesives, tapes, or any chemical bonding agents. The present invention addresses this need.

### SUMMARY OF THE INVENTION

The present invention provides new designs of guardrail reflector/delineator mounting apparatuses, for example, fasteners, clips, mounting brackets, and so on, and methods of mounting high visibility reflectors/delineators onto standard guardrails, concrete barriers, or any desired surface utilizing the same.

In some embodiments, the mounting apparatus has two main components or portions: an adjustable means and a mounting means. The adjustable means is securely attached or otherwise made part of the mounting means and enables an end user to quickly adjust, i.e., extend or reduce, the height of the mounting apparatus for a tight fit and secure hold onto the guardrail.

In an embodiment, the adjustable means is a modified turnbuckle with one or more screw or mounting holes and the mounting means is a rectangular shaped plate or the like, made of aluminum, stainless steel, molded plastic, alloy, rubber, recycled material, or other comparable strong and weather resistant material.

Conventionally, a turnbuckle is used to tighten or loosen rope or wire and has of a sleeve through which the rope or wire is threaded and held so that the tension can be adjusted. One skilled in the art will appreciate that the adjustable means according to the present invention does not have to be modified from off-the-shelf turnbuckles. The adjustable means can be any hollow tubular member having at least one adjustable end and one or more screw or mounting holes thereof. Such a hollow tubular member should be of a length and size that allows it to fit snugly into the space between the top and bottom portions of the guardrail.

In an example, the adjustable means is securely attached to the mounting plate with a screw. In this case, the mounting plate has at least two holes, one for attaching the modified turnbuckle and one or more for attaching a reflector/delineator thereto.

In another embodiment, the mounting apparatus is characterized as one single piece having an adjustable portion and a mounting portion. The adjustable portion in one embodiment is hollow and threaded inside at two ends for receiving two appropriate screws. In another embodiment the adjustable portion is hollow and holds two pillars, each having at least one pointy ends, that are connected by a spring, coil, or other flexible means positioned inside the hollow body. The mounting portion has one or more holes, recessed areas, or cavities suitable for mounting a desired reflector/delineator or any reflective/prismatic/delineative material, panel, or device thereon with one or more screws, hooks, clips, fasteners, nails, etc. The single piece mounting apparatus is made of aluminum, stainless steel, molded plastic, alloy, rubber, or other comparable strong and weather resistant materials, including recycled materials.

Similar to the above turnbuckle-and-plate mounting apparatus example, an end user can quickly adjust the height of the single piece mounting apparatus by turning one or both screws at the adjustable portion by hand, or by depressing the spring that connects the two pillars inside the adjustable portion with a hand tool and releasing the spring at an appropriate location that allows the extended pillars to securely hold on to the guardrail via their tapered or pointy ends. The guardrail may optionally have corresponding dents, notches, or the likes for receiving the pointy ends.

In a specific embodiment, the single piece mounting apparatus takes a general appearance of a turnbuckle with two adjustable ends, e.g., screws or pillars with pointy ends, for mounting securely onto a guardrail and one or more holes, recessed areas, cavities, or threaded studs/bolts suitable for mounting a reflector/delineator or any reflective/prismatic/delineative material, panel, or device thereon with one or more screws, hooks, clips, fasteners, nails, nuts, etc.

In yet another embodiment, the mounting apparatus takes a general appearance of a mounting plate having two pointy ends and two or more screw holes. The mounting apparatus further comprises a length adjusting means, e.g., a flexible back panel permanently attached to the mounting plate towards the two pointy ends thereof. The entire length of the mounting plate can be adjusted by turning a screw, by hand or with a hand tool such as a screwdriver, to increase or reduce the strain placed on either or both the mounting plate and the back panel.

The mounting apparatuses of the present invention are durable, long lasting, weather/temperature resistant, virtually maintenance free, easy to install, and relatively cost effective. Most importantly, they ensure that the reflectors/delineators are firmly attached to guardrails, including old and new, existing and otherwise to be installed ones, in a convenient and effortless manner, without affecting the safety feature, display utility, and visibility of the reflectors/delineators mounted thereon.

Still further objects and advantages of the present invention will become apparent to one of ordinary skill in the art upon reading and understanding the detailed description of the preferred embodiments and the drawings illustrating the preferred embodiments disclosed herein.

### BRIEF DESCRIPTION OF THE DRAWINGS

FIG. 1 illustrates an exemplary embodiment of the present invention having two components, an adjustable part and a mounting part, assembled together with one screw.

FIG. 2 illustrates an implementation of the mounting apparatus in one single piece.

FIGS. 3A-B respectively illustrates implementations of the single piece mounting apparatus with one or more mounting screws and built-in corresponding holes/recessed areas/cavities through which a reflector/delineator/marker can be directly attached.

FIG. 4 illustrates a quick-release implementation that can also be embodied in FIGS. 1, 2, 3A, and 3B.

FIGS. 5A-B respectively illustrates exemplary implementations of the mounting apparatus with a built-in adjustable portion.

FIGS. 6A-B respectively illustrates exemplary implementations of the mounting apparatus with a clip or bracket that is curved to fit the center portion of standard guardrails and attachable to a guardrail by screws or nails.

FIG. 6C is a photograph of the mounting bracket embodiment of FIGS. 6A and 6B.

FIGS. 7A-B respectively illustrates exemplary implementations of the mounting apparatus with a self-tightening threaded pin or screw.

FIGS. 8-11A show various self-tightening embodiments of the mounting apparatus.

FIG. 12A is a photograph showing three mounting apparatuses of the present invention installed on a guardrail.

FIG. 12B is a photograph showing a commercially available 3M™ LDS panel installed on the guardrail of FIG. 12A. The locations of the standard pre-drilled holes of the LDS panel match those on the underlying mounting apparatuses.

### DETAILED DESCRIPTION OF THE PREFERRED EMBODIMENTS

Although the following detailed description contains many specifics for the purposes of illustration, anyone of ordinary skill in the art will readily appreciate that many variations and alterations to the following exemplary details are within the scope of the invention. Accordingly, the following preferred embodiments of the invention are set forth without any loss of generality to, and without imposing limitations upon, the claimed invention.

In some embodiments, the present invention is particularly useful in mounting reflective plates or panels such as those disclosed in U.S. Pat. No. 5,975,706, entitled “A WIDE INCIDENT ANGLE REFLECTIVE PLATE”, issued to Nakayama and assigned to 3M Innovative Properties Company, St. Paul, Minn., USA, and the 3M Scotchlite™ Linear Delineation System, Series 344/346, hereinafter referred to as the LDS panels.

The LDS panels provide retroreflection across a very wide range of entrance and observation angles and are provided in 4″ or 6″ widths with a standard length of 36″ before installation. The LDS panels can currently be installed on concrete barriers with power drills and anchor bolts at a rate of 60 panels per an hour for a 4-person crew or on metal guardrails with brackets and glues at a rate of 40 panels per an hour for a 4-person crew. Prior to a typical installation, the concrete barrier or guardrail is marked. The guardrail surface where the brackets will be installed is sanded with a wire brush or sander and cleaned with rubbing alcohol or isopropyl alcohol. An adhesive is applied to each bracket in dry weather conditions and takes 8 hours or more to cure.

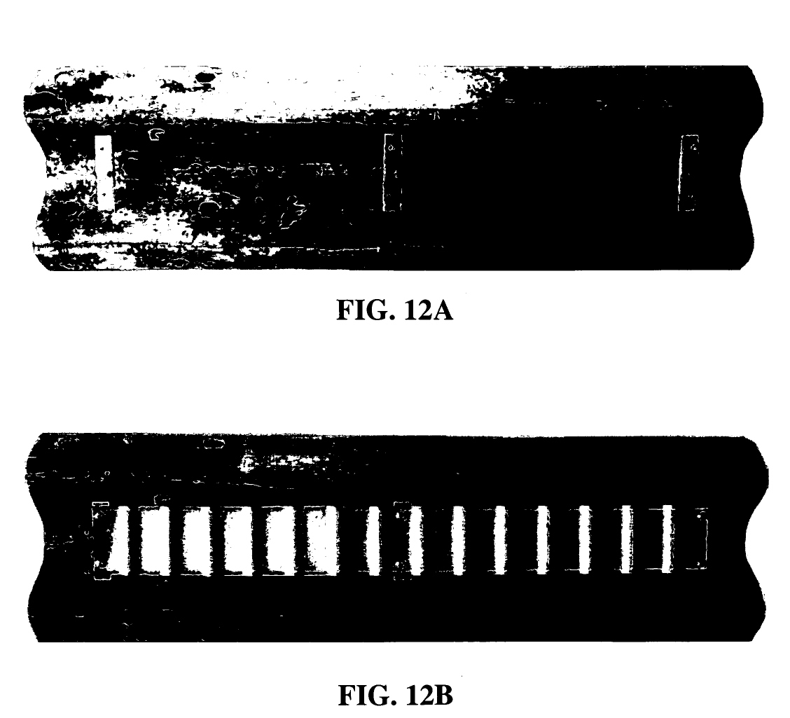

The present invention advantageously enables these LDS panels be installed on standard guardrails without needing to prepare, cleaning, and/or sand the surface thereof, and without glues, adhesives, tapes, or other chemical bonding agents. In a more specific example, using three mounting apparatuses disclosed herein, see FIGS. 12A and 12B, one person can easily install an LDS panel on a standard guardrail, by hand or with a simple hand tool, in about 30 seconds or less, thereby significantly reducing time and manual labor involved.

The standard guardrail referenced herein is known as a W-beam guardrail constructed of high-strength 12 gauge (Class A) or 10 gauge (Class B) steel and coated in rust-resistant zinc. The standard guardrail generally comes in 25′ and 12′6″ lengths and has several standard center-punching holes.

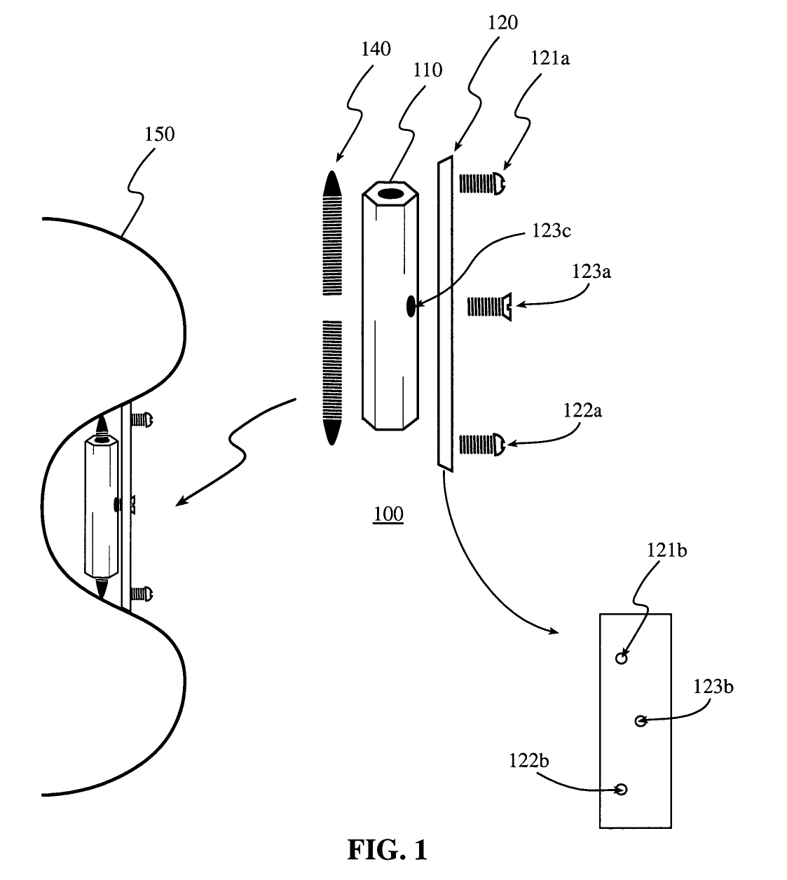

FIG. 1 illustrates an exemplary embodiment of a guardrail reflector/delineator mounting apparatus 100 having two components, a mounting part 120 and an adjustable part comprising a body 110 and two screws 140.

The adjustable part enables an end user to quickly adjust, i.e., extend or reduce, the height of the mounting apparatus 100 for a tight fit and secure hold onto the guardrail 150 (in side view). In this embodiment, the adjustable part is modified from a standard, zinc plated turnbuckle of 0.5″ (inner diameter)×7.5″ (height). The body 110 of the modified turnbuckle is about 3″ in height, adjustable to about 5.5″ via the two 1.5″ screws 140, and has one or more screw holes 123c as shown in FIG. 1. One skilled in the art will appreciate that the present invention is not limited by the specific size and type of turnbuckles disclosed herein. As discussed above, any hollow tubular member that can be readily modified or machined to implement the adjustable portion of the mounting apparatus described herein is within the spirit of the invention.

The mounting part 120 is a rectangular shaped plate, or the like, made of aluminum, stainless steel, molded plastic, or other comparable strong and weather resistant material and has two or more holes 121b, 122b, and 123b, one for attaching the turnbuckle and one or two or more for attaching an LDS panel or any suitable reflector/delineator thereon.

In this example, the turnbuckle is securely attached to the guardrail 150 via the adjustable screws 140 and to the mounting plate 120 via a screw 123a. An LDS panel is attachable to the mounting plate 120 via screws 121a and 123a.

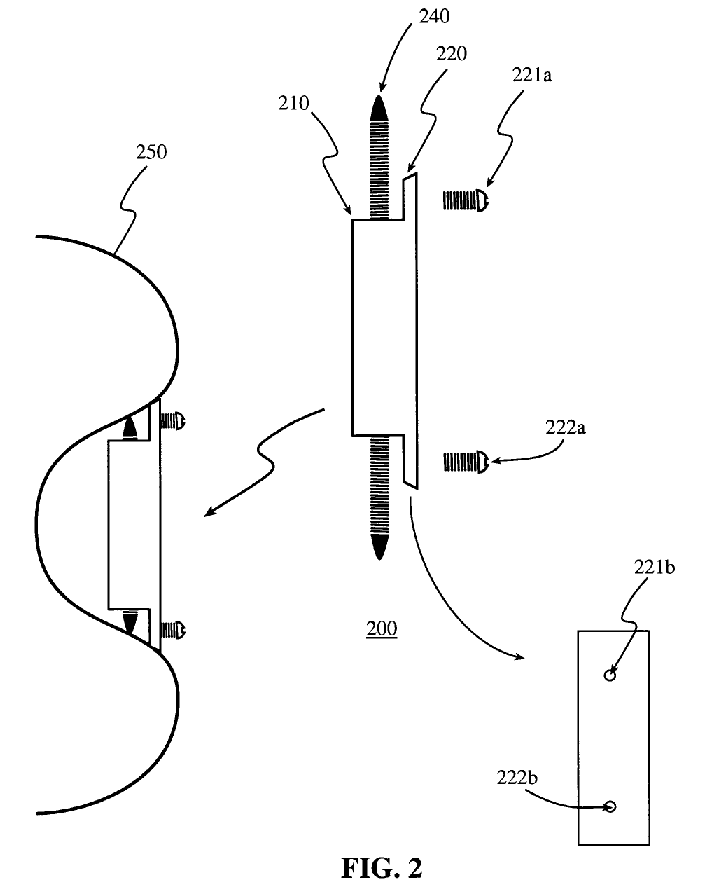

FIG. 2 illustrates a single piece mounting apparatus 200 having an adjusting portion 210 and a mounting portion 220. The adjusting portion 210 is hollow and threaded inside at two ends appropriate for receiving two height-adjusting means 240, e.g., screws or pillars with pointy ends. Similar to the above example, an end user can quickly adjust, e.g., by hand, the height of the mounting apparatus 200 by turning one or both height-adjusting screws 240 for a tight fit and secure hold onto the guardrail 250.

The mounting portion 220 has one or more holes, recessed areas, or cavities, e.g., 221b and 222b, that are suitable for mounting a desired reflector/delineator or any reflective, prismatic, delineative material, panel, or device thereon with one or more screws, hooks, clips, fasteners, nails, etc., e.g., 221a and 222a. The single piece mounting apparatus 200 is preferably made of aluminum, stainless steel, molded plastic, or other comparable strong and weather resistant material.

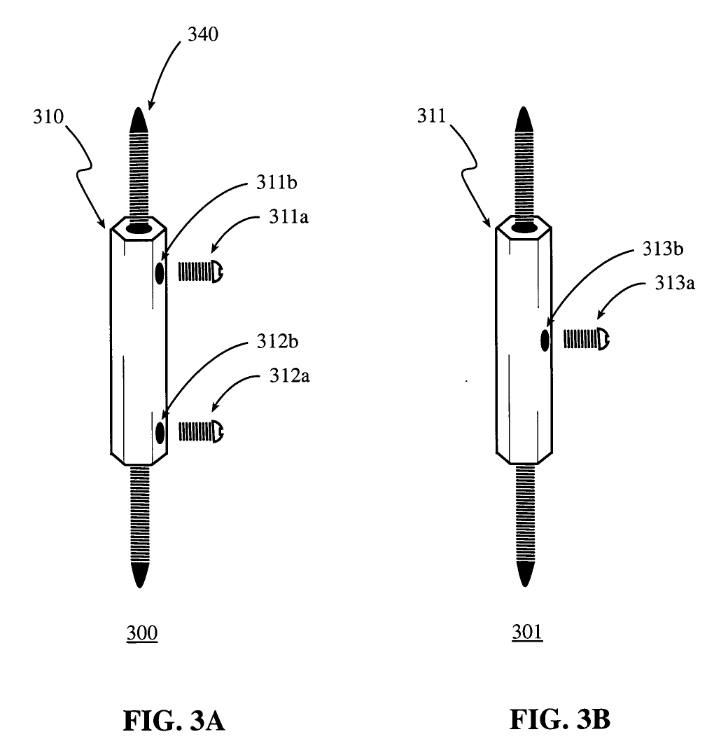

FIGS. 3A-B respectively illustrates other single piece embodiments with one or more mounting screws and built-in corresponding holes/recessed areas/cavities through which a reflector/delineator/marker can be directly attached. Each mounting apparatus 300 and 301 takes a general appearance of a turnbuckle with a body, 310 and 311, having one or more holes, recessed areas, cavities, or threaded studs/bolts, e.g., 311b, 312b, 313b, that are suitable for mounting a reflector/delineator or any reflective/prismatic/delineative material, panel, or device thereon with one or more screws, hooks, clips, fasteners, nails, nuts, etc., e.g., 311a, 312a, 313a. The body is hollow inside appropriate for receiving two adjustable ends 340 that enables the mounting apparatus to mount securely onto a guardrail (not shown).

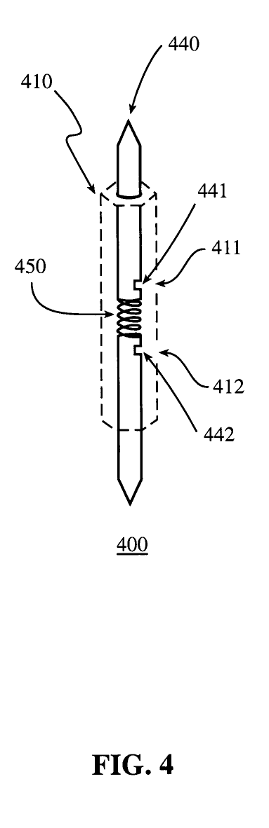

FIG. 4 illustrates a quick-release embodiment that can also be implemented in FIGS. 1, 2, 3A and 3B. The apparatus 400 has a body 410 and two height adjusting means 440, for instance, pillars, sticks, or rods, each with at least one pointy end. Each height adjusting means 440 has an indentation, notch, or recessed area located near one end thereof that is connected to a spring or coil 450 positioned inside of the body 410. The body 410 has two holes or small windows 411-412 through which the spring or coil 450 is adjustable, i.e., depressed or relaxed, by clipping or releasing notches 441-442. As such, the apparatus 400 can be quickly installed on or released from a guardrail (not shown). Moreover, when implemented in FIGS. 1, 2, 3A and 3B, the apparatus 400 enables the underlying mounting apparatus to be quickly installed on or released from a guardrail (not shown). Where applicable, the body 410 may have one or more screw/mounting holes appropriate for mounting a reflector/delineator or any reflective/prismatic/delineative material, panel, or device thereon. If so desired, one can first create two small dints on the guardrail at corresponding locations where the height-adjusting means or screws 440 are to be installed.

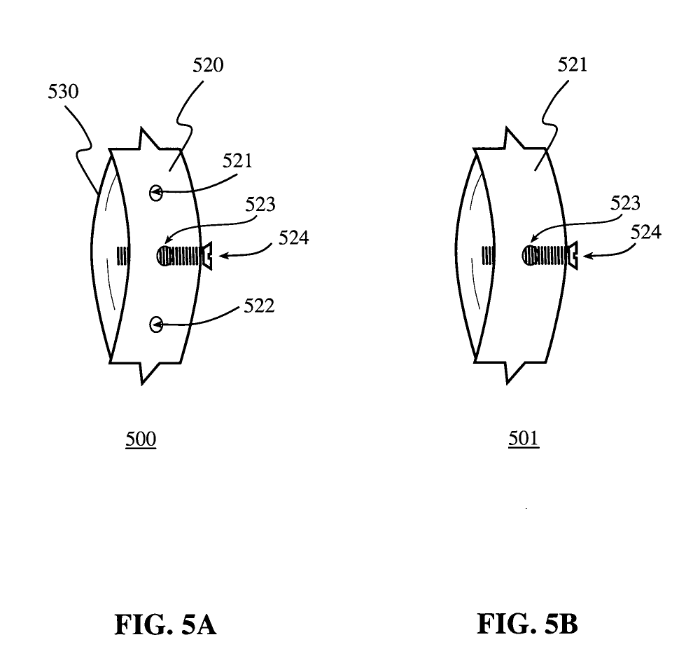

FIGS. 5A and 5B respectively illustrates an embodiment implementing the mounting apparatus of the present invention with a built-in adjustable portion. The mounting apparatus 500 has a mounting plate 520 with two pointy ends and three holes 521, 522, 523. The mounting apparatus 500 further includes a length/height adjusting means 530, e.g., a flexible back panel, permanently attached to the mounting plate 520 towards the two pointy ends thereof. The entire length/height of the mounting apparatus 500 is adjustable by turning a screw 524, by hand or with a hand tool such as a screwdriver, to increase or reduce the strain placed on either or both the mounting plate 520 and the back panel 530. A reflector/delineator or any reflective/prismatic/delineative material, panel, or device is attachable to the mounting apparatus 500 through screw holes 521 and 522. The mounting apparatus 501 is similar to the mounting apparatus 500 and has a body 521 with one hole 523. The screw 524 facilitates both the adjustment of the length/height of the body 521 and the mounting of a reflector/delineator thereon.

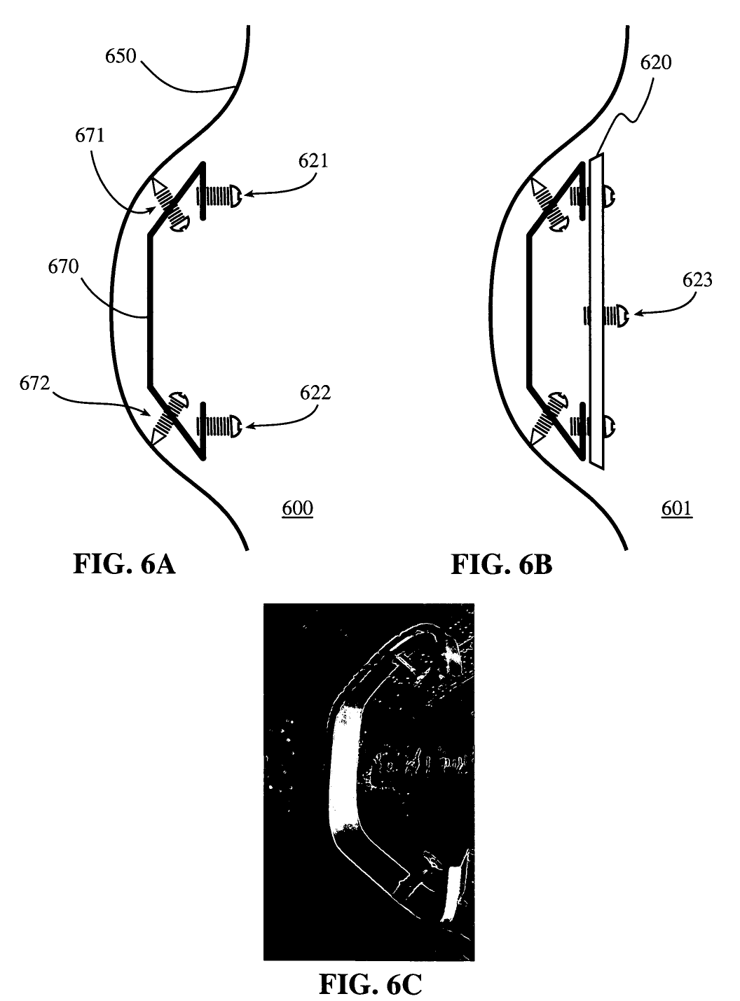

FIG. 6A illustrates a mounting apparatus 600 having a clip or bracket 670 that is curved, shaped, or bent to fit the center portion of a standard guardrail 650. That is, the shape of the clip or bracket 670 mimics or resembles a profile of the standard guardrail 650, as shown in FIG. 6A. The clip or bracket 670 is attachable to the guardrail 650 via screws or nails 671 and 672. A reflector/delineator or any reflective/prismatic/delineative material, panel, or device is attachable to the mounting apparatus 600 via screws 621, 622. FIG. 6B shows a similar mounting apparatus 601 integrated with a mounting part, plate, or panel 620 that has three screw holes, two for securely attaching the mounting part 620 to the clip or bracket 670 and one for mounting a desired reflector/delineator via a screw 623. FIG. 6C is a photograph showing a bracket installed on a guardrail.

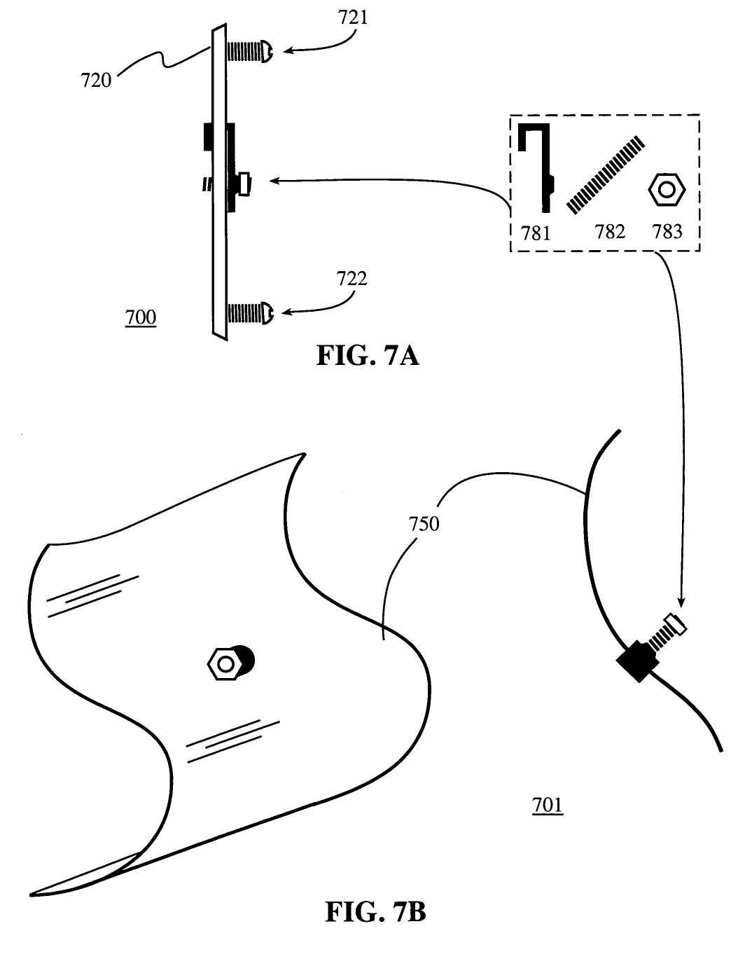

FIGS. 7A and 7B respectively illustrates an aspect of the present invention with a self-tightening threaded pin or screw and a way of mounting the same. The mounting apparatus 700 has a mounting assembly consisting of a small bracket 781, a threaded pin 782, and a nut 783, and an optional mounting plate 720 having holes or notches for mounting a reflector/delineator or the like via screws 721 and 722. The mounting apparatus 700 can be securely mounted to a guardrail 750 via the mounting assembly.

The mounting apparatus 701 is mounted to the guardrail 750 without the optional mounting plate 720. A desired marker, reflector, or delineator can then be mounted onto the mounting apparatus 701 via the nut 783. The bracket 781 is shaped in a way to catch the guardrail 750 via the standard guardrail support bolt, thereby stopping the screw 782 from turning when screwing the nut 783 on. In this case, no additional screws are necessary.

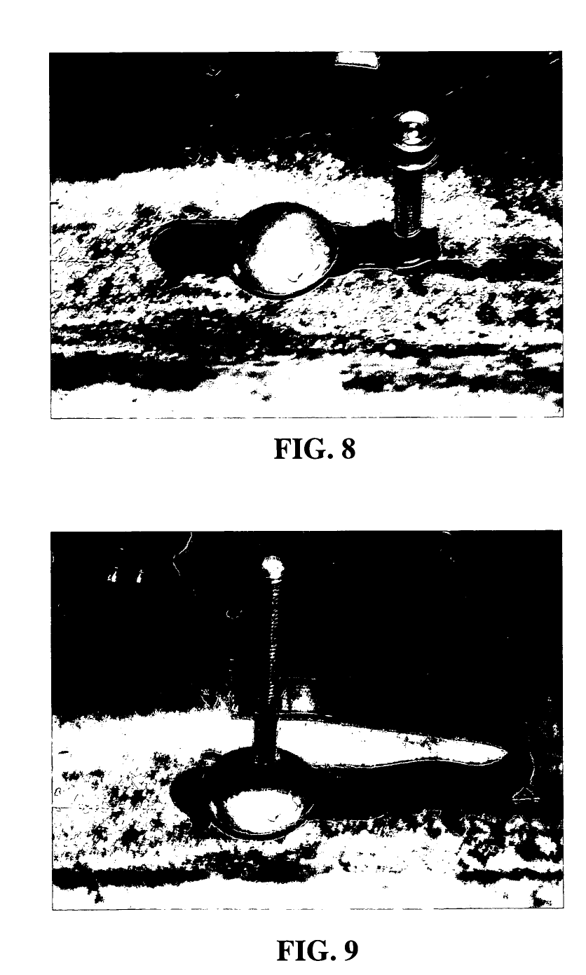

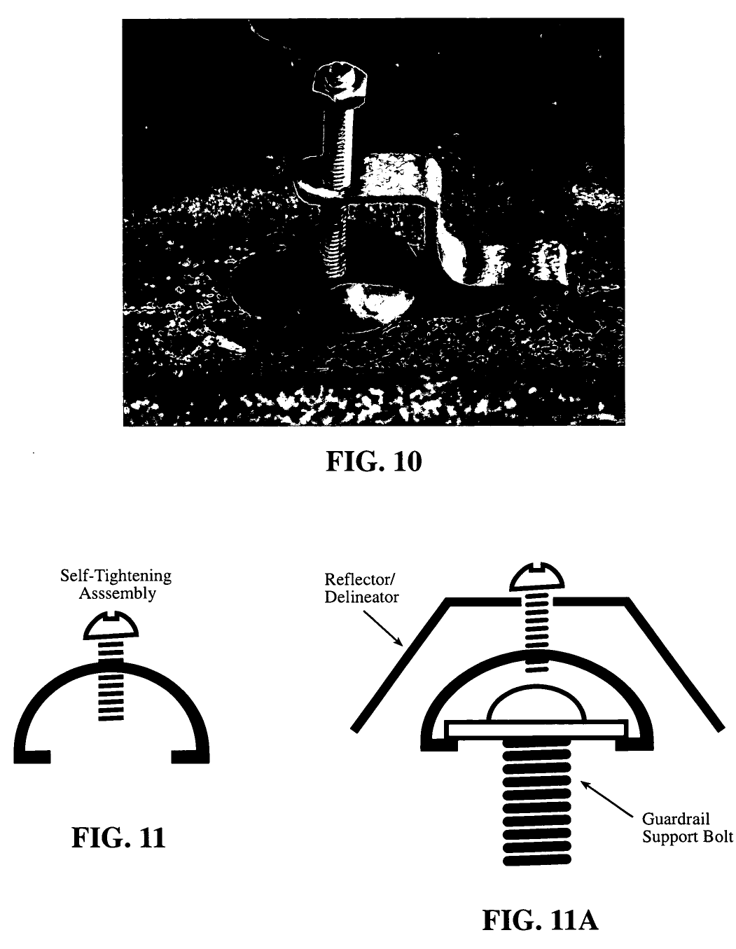

FIGS. 8, 9, 10 and 11 show various implementations of the self-tightening mounting apparatus having different brackets as well as different threaded pins or bolts. FIG. 11A exemplifies how a part, e.g., a threaded bolt, of the mounting apparatus of FIG. 11 functions to securely attach both a reflector/delineator and the mounting apparatus itself onto a guardrail support bolt. One skilled in the art will appreciate that the self-tightening mounting assembly is not limited to what is shown here. The bracket or clip as well as of the threaded pin or bolt may be varied in styles, designs, and shapes, for example, an “L” shape, so long as it can be securely attached to a guardrail support bolt.

The mounting apparatuses disclosed above are durable, long lasting, weather/temperature resistant, virtually maintenance free, easy to install, and relatively cost effective. Most importantly, they ensure that the reflectors/delineators are firmly attached to guardrails in an efficient and effortless manner, without affecting the safety feature, display utility, and visibility of the marker/reflectors/delineators mounted thereon.

Although the present invention and its advantages have been described in detail, it should be understood that the present invention is not limited to or defined by what is shown or discussed herein. The drawings, description and discussion herein show examples of the invention and provide examples of using the invention. One skilled in the art will realize that implementations of the present invention could be made without departing from the principles, spirit or legal scope of the present invention. Accordingly, the scope of the present invention should be determined by the following claims and their legal equivalents.

What is claimed is:

1. A mounting apparatus comprising:
an adjustable portion and a mounting portion; wherein
said adjustable portion is securely attached to or made a part of said mounting portion; and wherein
said mounting portion has one or more holes, recessed areas, cavities, or threaded studs or bolts for securely mounting a reflector, a marker, a delineator, or a prismatic or reflective material, panel, or device thereon with one or more screws, hooks, clips, fasteners, nails, or nuts.

2. The mounting apparatus of claim 1, wherein
said adjustable portion enables an end user to readily extend or reduce, by hand or with a hand tool, height of said mounting apparatus for a tight fit and secure hold onto a guardrail, concrete barrier, or desired surface.

3. The mounting apparatus of claim 1, wherein
said adjustable portion comprises a tubular body; wherein
said body is hollow and has one or more screw or mounting holes.

4. The mounting apparatus of claim 3, wherein
said adjustable portion further comprises two screws; and wherein
said body is threaded at both ends to receive said screws.

5. The mounting apparatus of claim 3, wherein
said adjustable portion further comprises two pillars and a spring, coil, or flexible means; wherein
each pillar has at least one pointy ends; and wherein
said pillars are connected by said spring, coil, or flexible means positioned inside said body.

6. The mounting apparatus of claim 1, wherein
said adjustable portion is a modified turnbuckle with one or more screw or mounting holes.

7. The mounting apparatus of claim 1, wherein
said mounting portion is a rectangular shaped plate having at least two holes, one for attaching said adjustable portion thereto and one or more for securely mounting said reflector, said marker, said delineator, or said prismatic or reflective material, panel, or device thereon.

8. The mounting apparatus of claim 1, wherein
said mounting portion is made of a weather resistant material, aluminum, stainless steel, molded plastic, rubber, or alloy.

9. The mounting apparatus of claim 1, wherein
said adjustable portion is a flexible back panel; wherein
said mounting portion has two pointy ends; and wherein
said flexible back panel is permanently attached to said mounting portion towards said pointy ends.

10. The mounting apparatus of claim 1, wherein
said adjustable portion is a clip or bracket having a shape that resembles a profile of a standard guardrail; and wherein
said adjustable portion has a plurality of holes for attaching said adjustable portion to said guardrail and to said mounting portion.

11. A mounting apparatus comprising:
a self-tightening mounting assembly for securely mounting a reflector, a marker, a delineator, or a prismatic or reflective material, panel, or device thereon; wherein
said mounting assembly comprises a bracket and a threaded pin or screw.

12. The mounting apparatus of claim 11, further comprising:
a mounting plate having a plurality of holes or notches.

13. The mounting apparatus of claim 11, wherein
said bracket is shaped to catch a standard guardrail support bolt so to stop said threaded pin or screw from turning when screwing said threaded pin or screw thereon, thereby enabling said self-tightening.

14. The mounting apparatus of claim 11, wherein
said mounting assembly further comprises a nut; and wherein
said bracket is shaped to catch a standard guardrail support bolt so to stop said threaded pin or screw from turning when screwing said nut thereon, thereby enabling said self-tightening.
